(19) United States
(12) Patent Application Publication
(10) Pub. No.: US 2026/0345406 A1
(43) Pub. Date: Nov. 5, 2026

(54) LOCOMOTION ASSISTANCE ASSEMBLY FOR THE PHYSICALLY IMPAIRED

(71) Applicant: Clemson University, Clemson, SC (US)

(72) Inventors: Isabella Henning, Clemson, SC (US); Lauren Philip, Clemson, SC (US); Audrey Martone, Clemson, SC (US); Hume Mitchell, Clemson, SC (US); Adam Gorlitsky, Clemson, SC (US); Larry Boyd, Clemson, SC (US); Brion Daffinson, Marietta, GA (US); Austin Howell, Lakewood, CO (US)

(73) Assignee: Clemson University, Clemson, SC (US)

(21) Appl. No.: 19/663,213

(22) Filed: Apr. 29, 2026

Related U.S. Application Data
(60) Provisional application No. 63/797,646, filed on Apr. 30, 2025.

(51) Int. Cl. A61G 5/14; A61G 5/12; A61H 3/04

(52) U.S. Cl. CPC A61G 5/14; A61G 5/124; A61G 5/128; A61H 3/04; A61H 2201/1623; A61H 2201/1635; A61H 2201/164

(57) ABSTRACT

The present disclosure provides a mobility assistance device for users with lower-limb paralysis. The device includes an external frame, an internal frame for holding a user's legs, and a sit-to-stand assembly. Elliptical-style handles are positioned at the user's mid-torso level, allowing the user to move left and right handles to actuate lower-limb movement via pedals at the base of the internal frame. The external frame incorporates front and back wheels connected to the handles for propelling the device. A sit-to-stand feature enables transition from a horizontal seating position to a vertical standing position. The device is manually operated using upper-body strength, allowing lower-limbs to mimic gait without direct leg force application. The assembly includes a backrest that functions as both a seat and back support, and a hydraulic pump system for position transitions.

### RELATED APPLICATIONS

This application to U.S. Provisional Application No. 63/797,646 , titled LOCOMOTION ASSISTANCE ASSEMBLY FOR THE PHYSICALLY IMPAIRED, filed Apr. 30, 2025, which is hereby incorporated by reference in its entirety.

### BACKGROUND

### Field of the Invention

The present disclosure relates to mobility assistance devices for individuals with lower limb impairments, and more particularly to a manually-operated locomotion assistance assembly incorporating a sit-to-stand mechanism and gait simulation capabilities.

### 2 Description of Related Art

Mobility assistance devices play a crucial role in improving the quality of life for individuals with limb impairments, especially lower limb impairments, including those that have completely lost the use of their legs. These devices aim to provide support and enable movement for those who have difficulty walking or standing independently or who cannot walk or stand independently. However, existing mobility aids often fall short in addressing the comprehensive needs of users with varying degrees of physical limitations. Many current mobility assistance devices suffer from limitations in functionality, versatility, and user-friendliness. For instance, traditional wheelchairs, while providing basic mobility, do not allow users to stand or simulate natural walking motions. Standing frames, on the other hand, offer the ability to achieve an upright position but lack mobility features. Robotic exoskeletons, which can provide both standing and walking capabilities, are often prohibitively expensive, require extensive training, and rely on complex powered systems that can be prone to failure.

Addressing these challenges is important for enhancing the independence and well-being of individuals with lower limb impairments. Improvements in this field could lead to increased mobility, better health outcomes through regular standing and movement, and greater social participation for users. Additionally, advancements in mobility assistance technology have the potential to reduce the physical strain on caregivers and healthcare professionals who assist individuals with limited mobility.

There is a clear need for innovative solutions that bridge the gap between existing mobility aids and the diverse needs of users. An ideal device would combine the benefits of standing, walking simulation, and independent mobility while remaining affordable, user-friendly, and reliable. Such a device could potentially revolutionize the way individuals with lower limb impairments navigate their daily lives and interact with their environment.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The present disclosure overcomes disadvantages in the prior art and provide a novel structure and function and can include, in certain embodiments, an external frame and an internal frame carried by the external frame and configured to hold a user's legs. A sit-to-stand assembly is coupled to the external frame and configured to transition a user between seated and standing positions. The assembly also includes an upper handle carried by the external frame and pedals disposed at the base of the internal frame operatively connected to the upper handle. Wheels are connected to the external frame and operatively coupled to the upper handles for propelling the assembly. A backrest is configured to function as both a seat in a seated position and a back support in a standing position. Actuation of the upper handles causes movement of the pedals and propulsion of the assembly.

Therefore, it is an object of the present invention to provide a locomotion assistance assembly that combines sitting and walking and the ability to transition between the two positions.

### BRIEF DESCRIPTION OF FIGURES

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 illustrates a perspective view of a locomotion assist assembly, according to aspects of the present disclosure.

FIGS. 2-3 depict perspective views of a mobility assistance device, according to an embodiment.

FIG. 4 shows a perspective view of another mobility assistance device, in accordance with example embodiments.

FIG. 5 illustrates a perspective view of a locomotion assist assembly with a belt drive system, according to aspects of the present disclosure.

FIG. 6 depicts a perspective view of a locomotion assist assembly with central drive assembly drive capability, according to an embodiment.

FIGS. 7A-7C show sequential perspective views of a locomotion assist assembly in operation, according to aspects of the present disclosure.

FIGS. 8A-8C illustrate sequential perspective views of a locomotion assist assembly with a drive belt system in operation, in accordance with example embodiments.

FIGS. 9A-9B illustrate a perspective view of a locomotion assist assembly.

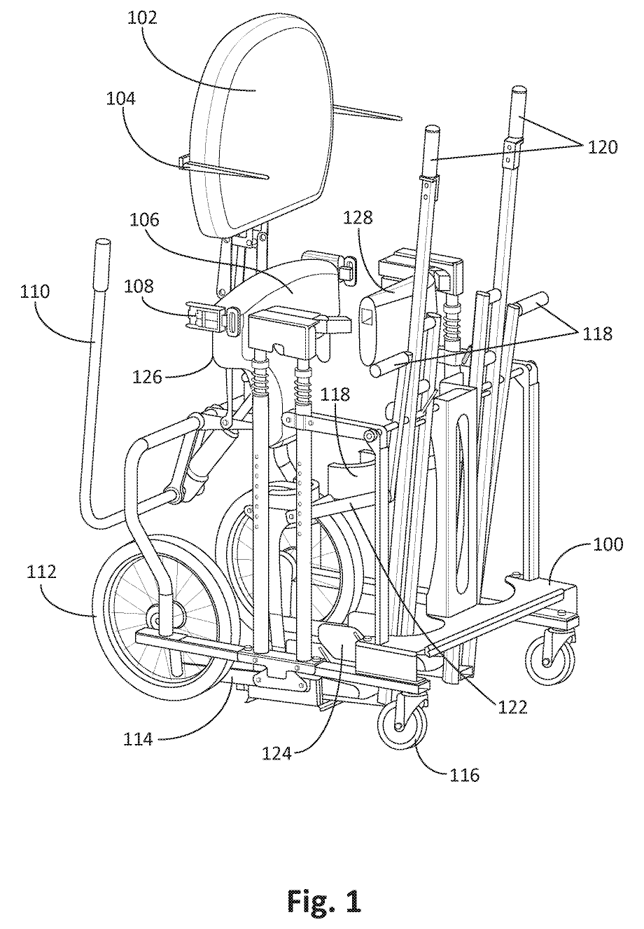

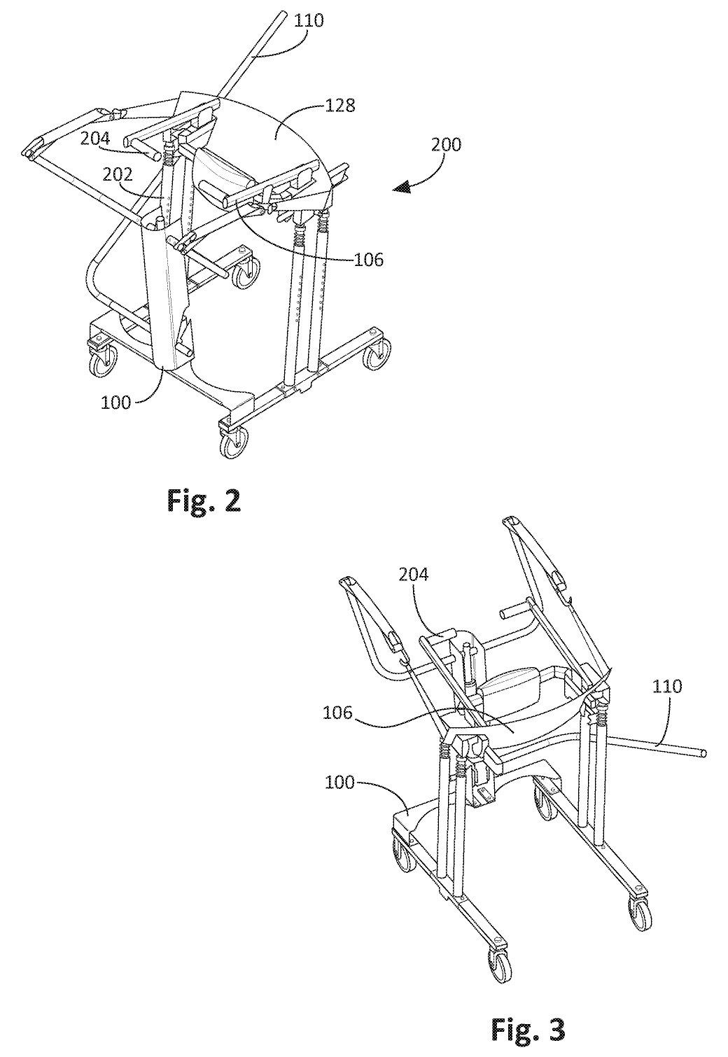

While each of the drawing figures depicts a particular embodiment for purposes of depicting a clear example, other embodiments may omit, add to, reorder, and/or modify any of the elements shown in the drawing figures. For purposes of depicting clear examples, one or more figures may be described with reference to one or more other figures, but using the particular arrangement depicted in the one or more other figures is not required in other embodiments. The drawings and schematic representations are intended to support the understanding of the invention. These may not be to scale and are not intended to limit the invention to any particular layout, connectivity, or architectural implementation. Correspondence between drawing elements and described components is provided for illustrative purposes and should not be interpreted to limit the claim scope.

### DETAILED DESCRIPTION

In the following description, for the purposes of explanation, numerous specific details are set forth in order to provide a thorough understanding of the present disclosure. It will be apparent, however, that the present disclosure may be practiced without these specific details. In other instances, well-known structures and devices are shown in block diagram form in order to avoid unnecessarily obscuring the present disclosure. Modifiers such as “first” and “second” may be used to differentiate elements, but the modifiers do not necessarily indicate any particular order.

With reference to the drawings, the invention will now be described in more detail.

The locomotion assist assembly may include an external frame 100 that provides the main structural support for the device. In some cases, the external frame 100 may be constructed from lightweight yet durable materials to ensure stability while maintaining portability. The assembly may incorporate an internal frame 122 within the external frame 100, which may provide additional structural integrity and support for various components.

As used herein, the term "cage assembly" may refer to the combination of the external frame 100 and the internal frame 122, which together form a structural enclosure that supports and surrounds the user during operation. The cage assembly may provide the overall structural framework that carries the various components of the locomotion assist assembly, including the backrest, handles, wheels, and foot pedals. In some cases, the cage assembly may be configured to stabilize the user while allowing for controlled movement and transitions between seated and standing positions.

At the upper portion of the assembly, an upper backrest support 102 and a backrest lateral support 104 may connect to a backrest 106. The later support can help in maintaining the patient in an upright position and keep the body of the patient between the lateral supports. The backrest 106 may provide support for a user's back during operation of the device. In some cases, a safety belt buckle 108 may be included to secure the user to the backrest 106, enhancing safety during use.

The locomotion assist assembly may feature a lift assembly 110 that can facilitate transitions between different positions or assist with other mechanical operations of the device. The hydraulic lift assembly can assist with transitioning between a sitting position and a standing position. The lift assembly can assist with a controlled transition between a standing position and a sitting position. For mobility, the assembly may include rear wheels 112 and front wheels 116. In some aspects, the front wheels 116 may be configured as support casters that provide stability and allow for omnidirectional movement of the assembly. These wheels may allow for smooth movement of the device on various surfaces. The lift assembly can be hydraulic.

To support and guide the user's feet, foot pedals 114 may be positioned at the lower portion of the device. The foot pedals 114 may be part of a larger pedal assembly 124, which may enable controlled leg movement for the user. In some cases, the pedal assembly 124 may be designed to mimic natural gait patterns.

The locomotion assist assembly may offer enhanced maneuverability through differential operation of the left and right wheels. In some cases, users may be able to control the direction of travel by varying the speed or direction of movement of each wheel independently. When the left and right wheels are operated at different speeds, the assembly may execute a turning motion. For example, if the right wheel rotates at a faster rate than the left wheel, the device may turn towards the left. Conversely, if the left wheel moves more rapidly than the right, the assembly may turn to the right.

In some instances, users may achieve more pronounced turning capabilities by rotating one wheel while keeping the other stationary. This differential movement may cause the device to pivot around the stationary wheel. For example, if the right wheel is rotated forward while the left wheel remains stationary, the assembly may rotate around the stationary left wheel, describing a counterclockwise circular path. Similarly, rotating the left wheel while keeping the right one stationary may result in a clockwise pivoting motion.

The ability to control each wheel independently may provide users with precise steering capabilities, potentially allowing for navigation in tight spaces or complex environments. This feature may enhance the overall versatility and usability of the locomotion assist assembly, enabling users to adapt to various spatial constraints and movement requirements in their daily activities.

The device may incorporate both lower locomotion handles 118 and upper locomotion handles 120. These handles may enable user-controlled movement of the device, allowing individuals to propel themselves using upper body strength. The dual handle configuration may provide options for users with different levels of upper body mobility or strength.

The lower locomotion handles 118 may serve as support handles to provide additional stability and assistance to the user. In some aspects, these handles may be positioned at a lower height compared to the upper locomotion handles 120, allowing users to grasp them comfortably while in a seated position. The lower handles may be rigidly attached to the external frame 100 or internal frame 122, providing a sturdy support point for users during various operations of the device. In some cases, users may utilize the lower handles to assist with weight distribution and balance when transitioning between seated and standing positions. The handles may be ergonomically designed to accommodate different hand sizes and grip strengths, potentially featuring contoured surfaces or non-slip coatings to enhance user comfort and safety.

The lower handles may also serve as anchor points for users during the locomotion process, offering additional stability when the device is in motion. In some embodiments, the lower handles may be adjustable in height or angle, allowing users to customize their position based on individual needs or preferences. This adjustability may enhance the overall versatility of the device, accommodating users of different heights or arm lengths. When configured for propulsion, the lower handles may, in some instances, allow users to make minor positional adjustments or assist with fine maneuvering in tight spaces. This feature may be particularly beneficial for users who require extra support or control during specific activities or in challenging environments.

A sit-stand assembly 126 may be included in the device, potentially allowing for transitions between seated and standing positions. This feature may offer users the ability to change postures, which may have potential health benefits. Complementing the sit-stand assembly 126, a chest rest 128 may provide additional support for the user during operation, particularly in a standing position. The assembly can promote movement for motion impaired patients, especially those undergoing rehabilitation due to injury, surgery, or overall health concerns, may offer numerous potential benefits.

In some aspects, the frame may provide a stabilizing cage structure configured to support the user. The stabilizing cage structure may be formed by the combination of the external frame 100 and the internal frame 122, which together create a structural enclosure that surrounds and supports the user during operation. In some cases, the stabilizing cage structure may include vertical support posts extending upward from the base frame, with lateral support members connecting the vertical posts to provide structural rigidity. The internal frame 122 may include an internal stabilizer or hip clamping mechanism configured to hold the user's waist and provide secure positioning within the cage structure. The stabilizing cage structure may include a support cage or partial enclosure with front and rear support elements. In some cases, the assembly may include a rear access gate or entry mechanism for ingress and egress. The rear access gate may be configured as a hinged gate positioned behind the user. In some embodiments, the hinged gate may hinge upward to allow the user to enter and exit the assembly. Once the user is positioned within the assembly, the hinged gate may be moved to a closed position and may be configured to lock in the closed position behind the user. When the hinged gate is locked in the closed position, the gate may work in conjunction with a padded front support region to fully encircle and stabilize the user's torso. The padded front support region may be configured to connect to rear frame elements, creating a firm connection between front and back portions of the stabilizing cage structure that encircles the user. In one embodiment, the structure may include a more stable cage configuration with a hip clamping mechanism and the hinged gate that locks behind the user to provide enhanced security and stability. A padded front support region may be configured to encircle the user, providing firm connection between front and back frame elements. The stabilizing cage structure may incorporate fail-safe stability features to reduce the risk of tipping or uncontrolled motion. In some cases, handle assemblies may be configured with ergonomic bends and positioning to improve comfort and arm biomechanics during prolonged use. In some aspects, the handles may have a bent configuration to position the handles closer to the user, reducing forward reach requirements. The handles may extend upward from the frame and include a bend or angled portion along the length of the handle shaft that directs the grip portion of the handles rearward toward the user. The angle of the bend may be configured to reduce the forward reach distance required by the user when grasping the handles. In some cases, the bend may be positioned at an intermediate location along the handle shaft, between the frame mounting point and the grip portion. The bent configuration of the handles may enhance user comfort by allowing for a more natural arm position during operation, reducing strain on the shoulders and arms during prolonged use. This configuration may improve arm biomechanics by allowing the user's arms to remain in a less extended position while operating the handles. This cage-like configuration may provide users with enhanced security and stability during operation of the device.

In some embodiments, the locomotion assist assembly may incorporate an alternative steering configuration in which turning control is moved toward a front wheel assembly. This configuration may utilize simplified steering linkages that reduce reliance on extensive chain-driven turning mechanisms. In some cases, the front casters may be configured to provide turning stability while maintaining frame clearance for wheelchair side loading. The simplified steering linkages may offer advantages in terms of reduced mechanical complexity and improved reliability. In some aspects, this front-wheel steering configuration may work in conjunction with rear support wheels or casters to maintain overall stability during turning maneuvers. The frame geometry may be adjusted to accommodate the front-wheel steering mechanism while preserving adequate clearance for users to transfer from a wheelchair positioned alongside the assembly.

Some of the benefits that are offered by this device include improved circulation through regular movement which may help enhance blood flow throughout the body, potentially reducing the risk of blood clots and promoting healing. The device may help maintain or improve muscle strength and tone while preventing atrophy that can occur during periods of inactivity. Movement facilitated by the assembly may help maintain or increase joint flexibility and range of motion, potentially reducing stiffness and improving overall mobility. Practicing movement exercises may contribute to better balance and coordination, which may be particularly important for preventing falls in patients with mobility issues. Even gentle movements provided by the device may offer cardiovascular benefits, potentially improving heart and lung function over time.

In some cases, controlled movement may help alleviate pain by promoting the release of endorphins and reducing muscle tension. Regular movement may help stimulate the digestive system, potentially reducing issues such as constipation that can occur with prolonged inactivity. Movement exercises may help improve lung capacity and respiratory efficiency, which may be especially beneficial for patients recovering from respiratory conditions. Physical activity may have positive effects on cognitive function, potentially improving mood, reducing stress, and enhancing overall mental well-being. Movement may stimulate the lymphatic system, potentially aiding in the removal of waste products and reducing swelling in some patients. Regular physical activity may contribute to improved sleep patterns, which can be crucial for recovery and overall health. Engaging in movement exercises may help patients regain or maintain functional independence in daily activities. Finally, achieving movement goals, even small ones, may boost confidence and motivation, potentially contributing to a more positive outlook during the rehabilitation process.

The arrangement of these components may work together to enable manual operation of the device through the coordinated use of the locomotion handles 118, 120 and the pedal assembly 124, while maintaining user support through the backrest 106 and chest rest 128 components. This configuration may allow users with lower limb mobility impairments to achieve a level of independent mobility and postural variation that may not be possible with traditional wheelchairs or standing frames. Engaging in physical movement is vital for individuals with physical impairments as it fosters improved mobility, enhances overall health, and contributes to a better quality of life, promoting independence and mental well-being.

In some aspects, the locomotion assist assembly may incorporate an open-frame design that facilitates integration with adjunct therapeutic devices. The open-frame configuration may provide easy access to the user's legs, which may be advantageous for use with functional electrical stimulation (FES) systems. In contrast to powered exoskeletons that enclose the user's legs and may make electrode placement cumbersome, the open-frame design of the locomotion assist assembly may allow for convenient placement and adjustment of FES electrodes during operation. The assembly may also be compatible with neuromodulation devices and brain-computer interface systems, potentially positioning the device as a system-level rehabilitation platform rather than only a mobility aid. In some cases, combining the structural gait support provided by the assembly with active muscle activation from FES or other neuromodulation therapies may produce synergistic rehabilitation effects that promote activity-dependent neuroplasticity. The assembly may further be compatible with pharmaceutical therapy and cellular therapy for conditions such as spinal cord injury or stroke. By enabling high-frequency, task-specific motor practice outside scheduled therapy appointments, the locomotion assist assembly may help reduce access barriers related to geography, cost, and scheduling while increasing patient autonomy and motivation during the rehabilitation process.

The locomotion assist assembly may include a sit-stand assembly 200 that enables users to transition between seated and standing positions. In some cases, the sit-stand assembly 200 may be integrated with the external frame 100 to provide a stable support structure during position changes. The sit-stand assembly 200 may incorporate a hydraulic lift assembly 110 that facilitates the transition between sitting and standing positions. In some cases, the hydraulic lift assembly 110 may be configured to be positioned on either the left side or the right side of the device based on user preference. In some cases, the hydraulic lift assembly 110 may be connected to pistons 202 that magnify the force generated by the hydraulic lift assembly 110. This amplification of force may allow for smoother and more controlled transitions, potentially reducing strain on the user.

The backrest 106 may serve dual purposes within the sit-stand assembly 200. In a sitting position, the backrest 106 may function as a seat, providing support for the user's body weight. As the assembly transitions to a standing position, the backrest 106 may rotate to support the user's back, maintaining proper posture and stability. The chest rest 128 may be positioned to provide additional support during position changes. In a sitting position, the chest rest 128 may be disposed across the top of the user's legs. As the sit-stand assembly 200 transitions to a standing position, the chest rest 128 may move to support the front of the user's legs, potentially enhancing stability and comfort.

Lower handles 204 may be incorporated into the sit-stand assembly 200. These lower handles 204 may provide additional support points for users during the transition between sitting and standing positions. In some cases, the lower handles 204 may be adjustable to accommodate users of different heights or arm lengths.

The sit-stand assembly 200 may offer several potential benefits for users with lower limb impairments. By enabling transitions between sitting and standing positions, the assembly may help reduce the risk of complications associated with prolonged sitting, such as pressure sores or circulatory issues. The ability to achieve a standing position may also allow users to interact with their environment at eye level, potentially improving social interactions and overall quality of life.

In some cases, the sit-stand assembly 200 may assist users in transferring between the locomotion assist assembly and a wheelchair. The ability to adjust between sitting and standing positions may allow users to align the seat height with that of a wheelchair, potentially facilitating safer and easier transfers. This feature may reduce the need for multiple assistive devices, as the locomotion assist assembly may function effectively in both seated and standing configurations.

The integration of the sit-stand assembly 200 within the locomotion assist assembly may provide users with a versatile mobility solution. By offering both seated and standing options within a single device, users may have greater flexibility in navigating various environments and performing different activities throughout their day.

In some embodiments, the sit-stand assembly 200 may incorporate a rotating seat mechanism to facilitate user transfer from a wheelchair. The rotating seat mechanism may allow the seat to rotate outward from the frame structure, providing free space for the user to transfer from their wheelchair without being confined by the external frame. In some cases, the rotating mechanism may include a locking feature configured to secure the seat in a desired position during transfer and during operation. Once the user is positioned on the seat, the rotating mechanism may rotate the user in a controlled manner back into the assembly, allowing the user to position their legs into the foot pedals and knee straps using their upper body. This rotating seat configuration may address challenges associated with users having to maneuver their legs into a confined space within the external frame during transfer. In some aspects, the rotating mechanism may enhance the ease of transfer for users with varying degrees of spinal cord injuries or other mobility impairments.

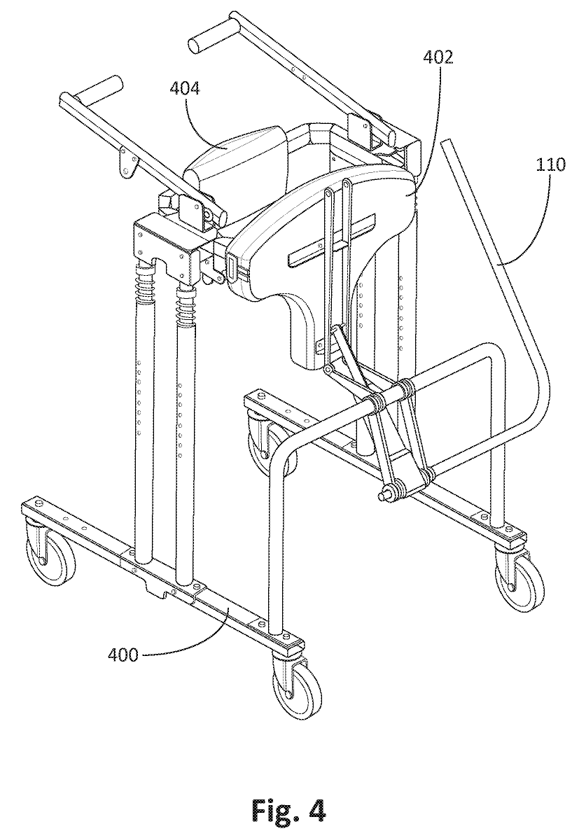

In one embodiment, the assist assembly may include a sit-to-stand configuration as illustrated in FIG. 4. This configuration may incorporate a frame 400 that provides structural support for the overall assembly. In some cases, the frame 400 may be designed to offer enhanced stability during transitions between sitting and standing positions. In one embodiment, a seat backrest 402 mounted to the frame 400 is included. The seat backrest 402 may be designed to function as both a seat and a backrest, depending on the device's configuration. In a sitting position, the seat backrest 402 may provide a comfortable seating surface for the user. As the device transitions to a standing position, the seat backrest 402 may rotate to support the user's back, potentially offering continuous support throughout the movement.

In one embodiment, the device may also include a rigid front support 404 positioned to provide additional stability and support for the user. In some cases, the rigid front support 404 may be adjustable to accommodate users of different heights or body types. In one embodiment, the sit-to-stand assembly may incorporate the hydraulic lift assembly 110 to enable controlled movement between different positions. The hydraulic lift assembly 110 may work in conjunction with the seat backrest 402 and the rigid front support 404 to facilitate smooth transitions between seated and standing positions.

The device configuration may offer several potential advantages. The dual-function seat backrest 402 may reduce the overall complexity of the device by combining two components into one. This design may result in a more compact and lightweight assembly, potentially enhancing portability and maneuverability. In some cases, the continuous support provided by the seat backrest 402 throughout the sit-to-stand transition may enhance user comfort and stability. The seamless transition from seat to backrest may reduce the need for repositioning during the movement, potentially making the process easier and more comfortable for users with limited mobility. The device may also offer increased versatility. By incorporating a seat backrest 402 that functions in both seated and standing positions, the device may be more adaptable to different user needs and preferences. This flexibility may allow users to easily switch between sitting and standing positions as needed throughout their day, potentially promoting better posture and reducing the risks associated with prolonged sitting.

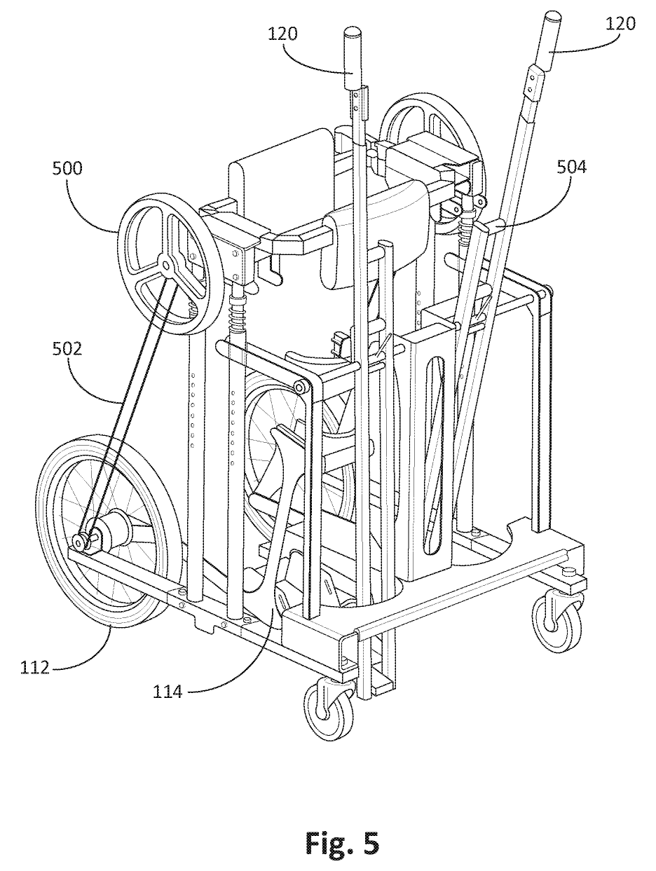

The locomotion assist assembly may include a drive mechanism featuring a drive belt system, as illustrated in FIG. 5. This system may enable efficient manual operation and coordinated movement of the device. In some cases, the drive mechanism may incorporate upper locomotion handles 120 positioned at a height suitable for user operation. These upper locomotion handles 120 may be carried by a drive belt pulley 500. The drive belt pulley 500 may be coupled to a rear wheel 112 via a drive belt 502. This configuration may allow for the translation of motion from the upper locomotion handles 120 to drive the rear wheel 112. The drive belt can associate the rotational energy of the drive belt pulley with the rear wheels.

The assembly may also include foot pedals 114 positioned near the base of the device. In some cases, the movement of the foot pedals 114 may be coordinated with the rotation of the rear wheel 112 through the drive belt system. This coordination may enable a controlled and rhythmic movement pattern that mimics natural gait.

Lower handles 504 may be provided as part of the assembly structure, potentially offering additional support or control options for users. The lower handles 504 may be positioned at a lower height compared to the upper locomotion handles 120, potentially accommodating users with different arm lengths or mobility levels. In some cases, the lower handles 504 may be utilized to provide locomotion when the user is in a seated position.

The use of the drive belt system may provide control over the gait and pace of the foot pedal movement. In some cases, the gear ratios within the drive belt pulley 500 may be adjusted to modify the relationship between handle movement and foot pedal motion. This adjustability may allow for customization of the gait pattern to suit individual user needs or preferences. The arrangement of the drive belt pulley 500 and drive belt 502 may enable a mechanical advantage, potentially reducing the effort required by the user to propel the device. This efficiency may be particularly beneficial for users with limited upper body strength or endurance. In some cases, the drive belt system may also incorporate a mechanism for reversing the direction of motion. This feature may allow users to move the device backwards by reversing the direction of handle movement, potentially enhancing maneuverability in tight spaces.

The integration of the drive belt system with the upper locomotion handles 120 and/or lower handles 504 and foot pedals 114 may create a coordinated drive mechanism that enables users to achieve controlled mobility through manual operation. This system may offer a means of locomotion that utilizes upper body strength while providing a natural leg movement pattern, potentially benefiting users with lower limb mobility impairments.

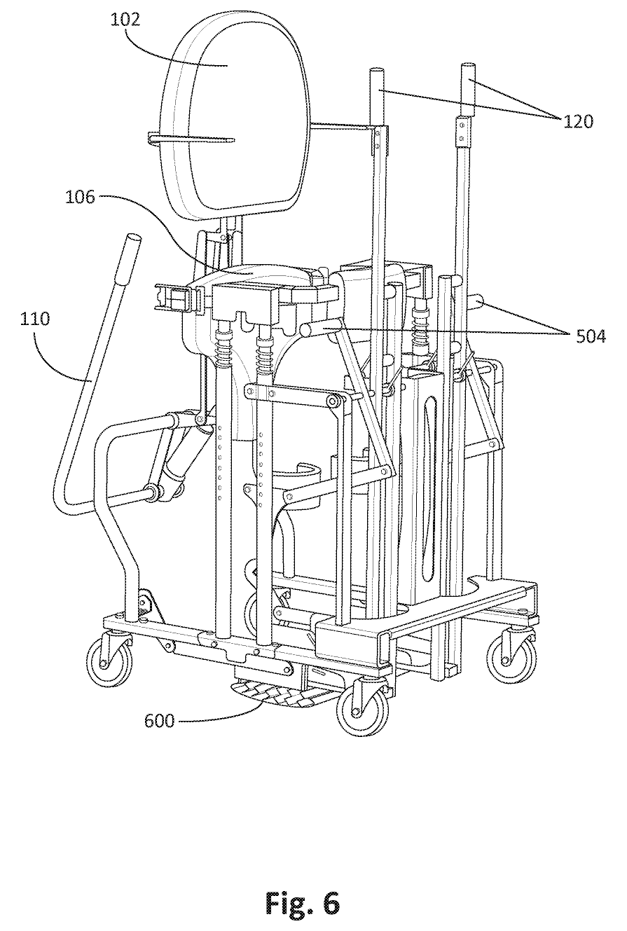

The locomotion assist assembly may include a configuration with central drive assembly, as illustrated in FIG. 6. This configuration may incorporate several components to enhance stability and user control during operation. A central drive assembly 600 may be included at the base of the assembly. The central drive assembly 600 may provide additional stability during operation, particularly when the device is stationary or during transitions between seated and standing positions. In some cases, the central drive assembly 600 may be adjustable to accommodate different user heights or preferences. In some embodiments, the assembly may incorporate a wheel configuration with a single central drive wheel positioned at the rear of the assembly. In this configuration, rear side wheels may be configured as support casters, and front casters may be provided for turning capability, resulting in a total of five wheels. The central drive wheel may be driven and synchronized with both arms to provide propulsion. In some cases, the central drive wheel may include power assist potential, and when power assist is engaged, the leg motion may be disengaged to allow for powered locomotion independent of the gait mechanism.

In some embodiments, the central drive wheel may include an optional power-assist feature that allows for powered locomotion when desired. The power-assist may be selectable by the user, enabling switching between manual gait-driven operation and powered operation. When power-assist is engaged, the leg motion mechanism may be disengaged or decoupled from the drive system to allow for powered locomotion independent of the gait mechanism. In some cases, a clutch or decoupling mechanism may be included to disengage the leg motion linkage from the drive system when power-assist is active. This configuration may allow users to conserve energy during longer travel distances or when navigating challenging terrain by utilizing powered propulsion rather than manual gait-driven movement. The ability to switch between manual and powered modes may provide users with flexibility in how they operate the device based on their energy levels, environmental conditions, or personal preferences.

In some embodiments, the locomotion assist assembly may include a selectable propulsion coupling that allows the user to choose whether gait motion results in forward translation of the device. When the propulsion coupling is engaged, actuation of the handles may cause both leg movement and forward propulsion of the assembly. When the propulsion coupling is disengaged, the user may perform gait exercise movements while the device remains stationary. This stationary gait exercise mode may be beneficial for therapeutic purposes, allowing users to practice gait patterns and receive the benefits of leg movement without requiring space for device travel. The selectable propulsion coupling may be implemented through a clutch mechanism, a mechanical disconnect, or other decoupling arrangement between the gait mechanism and the drive system. In some cases, this feature may allow users to perform gait exercises in confined spaces or when stationary exercise is preferred over locomotion. The ability to decouple gait motion from forward translation may provide flexibility for users who wish to focus on rehabilitation exercises without the need to navigate through their environment.

The arrangement of the upper locomotion handles 120, lower handles 504, and central drive assembly 600 may work together to enhance the overall stability and control of the device. The central drive assembly 600 may provide a fixed point of contact with the ground, potentially reducing unwanted movement or tipping of the device during use.

In some aspects, the central drive assembly 600 may provide locomotion for the device. The central drive assembly 600 may incorporate a drive mechanism that enables forward and backward movement allowing users to navigate various environments. In some cases, the central drive assembly 600 may be configured as the primary or sole means of propulsion for the locomotion assist assembly. This configuration may offer advantages in terms of stability and control, as the centralized drive system may provide a balanced distribution of force during movement. The central drive assembly 600 may actuators that can be controlled by the user through various input methods, such as the upper locomotion handles 120. By centralizing the locomotion capabilities, the device may achieve improved maneuverability in tight spaces or on uneven surfaces. Additionally, the central drive assembly 600 may be designed to work in conjunction with the sit-stand assembly 200, potentially allowing for seamless transitions between seated and standing positions while maintaining mobility capabilities.

In some aspects, the locomotion assist assembly may incorporate a central drive track disposed along a length of the frame structure. The central drive track may run along the length of the frame and may be configured to guide and synchronize foot motion during operation. In some cases, the central drive track may be positioned along the middle of the device frame or may include track elements on both sides of the frame. The central drive track may comprise guide rails, channels, or elongated track members that define a guided footpath for the foot supports. In some embodiments, foot supports or footplate assemblies may be coupled to or travel along the central drive track via rollers, bearings, or sliding engagement members that constrain the foot supports to follow the track path. The central drive track may synchronize left and right foot motion through mechanical coupling or through the geometry of the track path itself, in a manner similar to an elliptical exercise machine. In some cases, the track profile may include curved or ramped sections that impart a subtle vertical lift to the foot supports during travel, enabling controlled ground engagement during the gait cycle while facilitating a natural gait pattern. The configuration may synchronize motion in a manner similar to an elliptical exercise frame. In some cases, the vertical component imparted by the central drive track may assist with clearing obstacles or uneven surfaces during operation. The central drive track may work in conjunction with the foot pedals 114 and the pedal assembly 124 to create an elongated travel path that simulates stride length while maintaining stability and user control.

In some embodiments, the locomotion assist assembly may include an arm-leg linkage that connects the handles to a position near or below the user's knee joint rather than at the foot or forefoot. This configuration may produce a flatter, ski-like trajectory for leg movement while still enabling substantial knee flexion during operation. In some cases, the arm-leg linkage may include a handle pivot bar mounted to the frame via a pivot bar bracket, establishing a pivot axis about which the handles rotate. The handles may be connected to extension arms or connector arms that transmit the rotational motion from the handles to leg support structures positioned near or below the user's knee. The pivot point location on the frame, combined with the connection point near or below the knee, may create a mechanical linkage geometry that constrains the leg movement to follow an elliptical path. As the user actuates the handles through a reciprocating push-pull motion about the pivot axis, the linkage geometry may translate this rotational input into an elliptical motion pathway for leg movement. In some cases, the elliptical trajectory may result from the combined rotational motion about the handle pivot point and the linear constraint provided by the central drive track or guide rails. The arm-leg linkage may transmit arm input from the handles to drive lower-limb motion through this knee-level connection, providing an elliptical motion pathway for leg movement when the handles are actuated. As the handles are actuated and the linkage lifts the lower portion of the leg, the upward motion may cause the knee joint to flex, guiding the leg through a bending motion that simulates the knee flexion characteristic of a natural gait cycle. In some cases, the elliptical motion pathway may have a longer travel path and a less steep trajectory compared to configurations where the linkage connects at the foot, while still maintaining the elliptical drive path characteristic of the gait cycle. This elliptical motion pathway may enable substantial knee flexion during leg movement, potentially providing therapeutic benefits for users with lower limb impairments. In some cases, the arm-leg linkage may work in conjunction with foot supports that include free-spinning elements, such as balls or rollers, configured to glide along a ground surface during operation. The free-spinning elements may include flexible ground-contact balls attached to the foot supports to allow rolling motion and terrain adaptation. In some embodiments, the free-spinning elements may be configured as unidirectional rollers that permit forward rolling motion while resisting backward movement. The foot supports may include multiple rollers, such as four rollers, positioned to support the user's feet during a shuffling, gliding motion. In some cases, the free-spinning elements may be configured to remain in contact with the ground surface during the gait cycle, tolerate uneven terrain, and support substantial loads. The free-spinning elements may be constructed from materials suitable for various floor types, including carpet, tile, concrete, and linoleum. This arrangement may allow for controlled ground engagement while maintaining a natural gait pattern with the user's feet contacting the ground during the gait cycle.

In some cases, the addition of the central drive assembly 600 may allow for more secure positioning of the device when the user is transferring in or out of the assembly. This enhanced stability may be particularly beneficial for users with limited mobility or balance issues. The configuration with central drive assembly may offer several potential advantages. By providing additional points of contact with the ground, the device may offer increased stability during various operations. This enhanced stability may allow users to feel more secure and confident while using the device, potentially encouraging more frequent use and greater independence.

The locomotion assist assembly may operate in a sequential manner to enable controlled movement for users with lower limb mobility impairments. In some cases, the operational sequence may begin with the assembly in a stationary position. The user may be securely positioned within the external frame, supported by the backrest and the chest rest. In some cases, the safety belt, connected to the frame with safety belt buckles, may be engaged to provide additional security during operation. The upper or lower handles are actuated which in turn cause the foot pedals to slide forward and rearward thereby moving the patient's feet and legs.

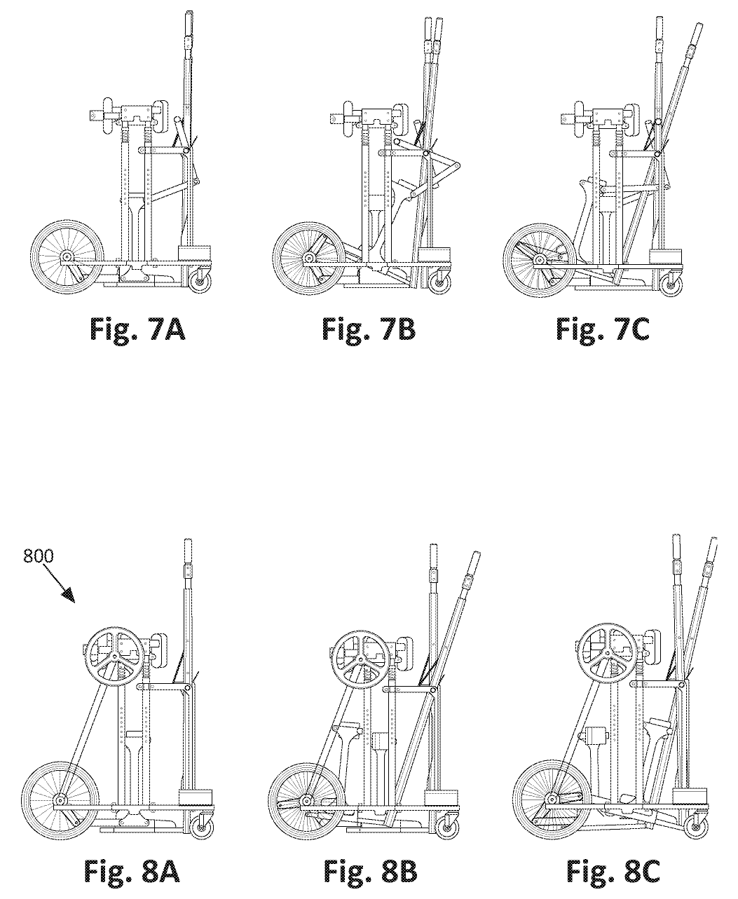

Referring to FIGS. 7A-7C and 8A-8C, as the handles are actuated, the foot pedals of the pedal assembly may begin to move in a reciprocating motion. This movement may mimic a natural walking pattern, potentially providing therapeutic benefits for the user's lower limbs. The coordination between the handle actuation and foot pedal movement may be achieved through the drive belt system 800. In some cases, the operational sequence may differ slightly when the basic configuration without the drive belt system 800 is used. In this configuration, the handle actuation may directly drive the rear wheel, potentially requiring more effort from the user. The foot pedal movement may still be coordinated with the handle actuation, but the mechanical advantage provided by the drive belt system 800 may not be present.

The lower handles may provide an alternative means of control, particularly when the user is in a seated position. In some cases, the lower handles may be used to position the foot pedals rearward or to provide finer control over the assembly's movement.

Throughout the operational sequence, the central drive assembly 600 (FIG. 6) may provide additional stability, particularly during transitions or when the assembly is stationary. In some cases, the operational sequence may allow for both forward and backward movement. The user may reverse the direction of handle actuation to move the assembly backwards, potentially enhancing maneuverability in confined spaces.

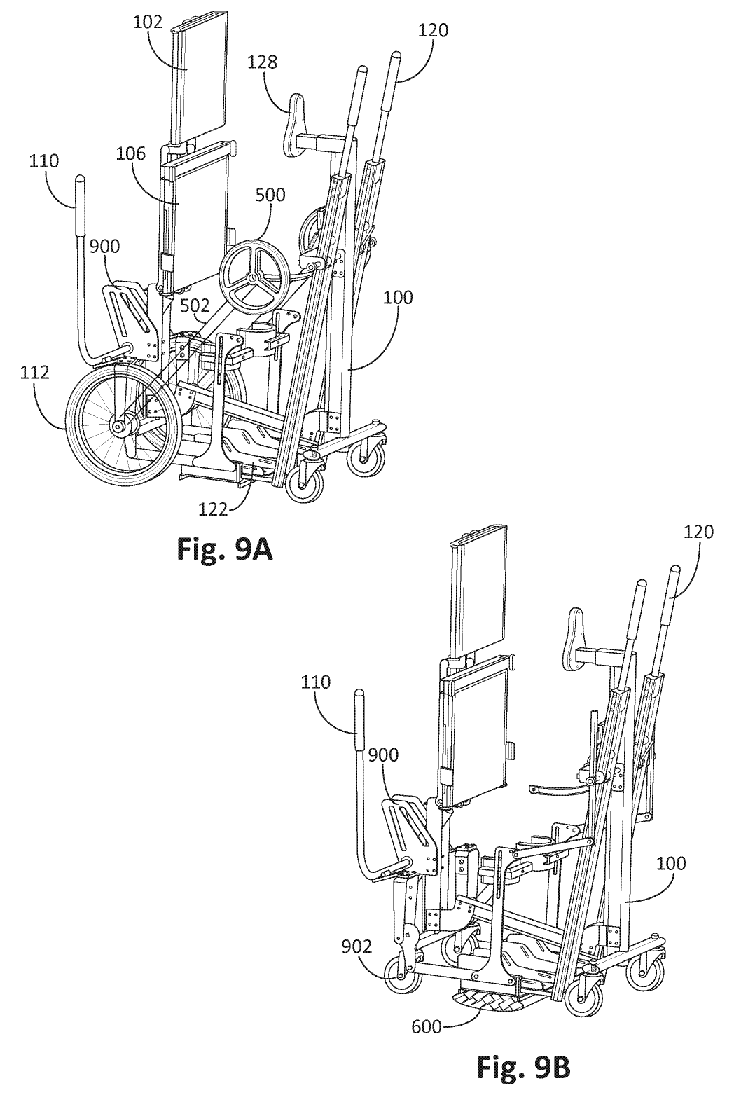

FIGS. 9A and 9B illustrate an embodiment of the components in a different arrangement. The device includes a hydraulic lift assembly 110, which may facilitate transitions between seated and standing positions and include a transaction bracket 900 connected to the external frame 100. This bracket may function in the device's transformational capabilities. A chest rest 128 is visible in the figures, which may offer additional support for the user during operation. At the base of the assembly, a central drive assembly 600 is present, which may enhance stability during use or when the device is stationary. The drive belt pulley 500 may be positioned forward of the rear wheel 112, as shown in FIGS. 9A and 9B. This configuration may allow for a more compact design and efficient power transfer from the upper locomotion handles 120 to the drive system.

A rear glider wheel 902 is depicted as being carried by the internal frame 122. This wheel may contribute to the overall mobility and maneuverability of the device, potentially allowing for smoother transitions or movements in certain scenarios.

The chest rest may feature an ergonomic shape designed to comfortably support the user's body, potentially reducing pressure points and enhancing overall comfort during extended periods of use. The chest rest may incorporate features to accommodate different body shapes and sizes, including variations between male and female users. The shape of the chest rest may be designed with a curved or contoured profile that can adapt to various chest and torso shapes.

The arrangement of these components in FIGS. 9A and 9B may demonstrate how the various elements of the locomotion assist assembly work together to provide a comprehensive mobility solution for users with lower limb impairments.

The locomotion assist assembly may offer enhanced maneuverability through differential operation of the left and right foot pedals. In some cases, users may be able to control the direction of travel by varying the speed or direction of movement of each foot pedal independently. When the left and right foot pedals are operated at different speeds, the assembly may execute a turning motion. For example, if the right foot pedal is actuated at a faster rate than the left foot pedal, the device may turn towards the left. Conversely, if the left foot pedal moves more rapidly than the right, the assembly may turn to the right.

In some instances, users may achieve more pronounced turning capabilities by moving one foot pedal forward while keeping the other stationary or moving it rearward. This differential movement may cause the device to travel in a circular path. For example, if the right foot pedal is pushed forward while the left foot pedal remains stationary, the assembly may rotate around the stationary left side, describing a counterclockwise circular path. Similarly, advancing the left foot pedal while keeping the right one stationary may result in a clockwise circular motion, e.g., a pivot.

The ability to control each foot pedal independently may provide users with precise steering capabilities, potentially allowing for navigation in tight spaces or complex environments. This feature may enhance the overall versatility and usability of the locomotion assist assembly, enabling users to adapt to various spatial constraints and movement requirements in their daily activities.

The sit-stand assembly may allow users to transition between seated and standing positions during the operational sequence. This feature may provide flexibility in use, potentially allowing users to adjust their position based on comfort or specific activities. The frame, incorporating both the external frame and the internal frame, may provide structural support throughout the operational sequence. The seat backrest and rigid front support may work in conjunction with the frame to maintain user stability during movement and position transitions.

One or more different inventions may be described in the present application. Further, for one or more of the invention(s) described herein, numerous embodiments may be described in this patent application, and are presented for illustrative purposes only. The embodiments described are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

It is understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. A locomotion assistance assembly comprising:
a cage assembly configured to hold a user's legs;
wheels carried by the cage assembly;
a sit-to-stand assembly coupled to the cage assembly and configured to transition a user between a seated position and a standing position;
upper handles carried by the cage assembly;
foot pedals disposed at a base of the cage assembly and operatively connected to the upper handles, wherein actuation of the upper handles causes movement of the foot pedals and propulsion; and
a backrest coupled to the cage assembly and configured to function as a seat when the user is in the seated position and as a back support when the user is in the standing position.

2. The locomotion assistance assembly of claim 1, including an internal frame and an external frame included in the cage assembly.

3. The locomotion assistance assembly of claim 2, further comprising a lift assembly coupled to the external frame and configured to assist with transitions between the seated position and the standing position.

4. The locomotion assistance assembly of claim 1, further comprising a lift assembly coupled to the cage assembly and configured to facilitate transitions between the seated position and the standing position.

5. The locomotion assistance assembly of claim 1, further comprising a drive belt system including a drive belt pulley carried by the cage assembly and coupled to a rear wheel via a drive belt, wherein actuation of the upper handles causes rotation of the drive belt pulley.

6. The locomotion assistance assembly of claim 1, further comprising a chest rest coupled to the cage assembly, wherein the chest rest is configured to be disposed across a top of the user's legs when the user is in the seated position and to support a front of the user's legs when the user is in the standing position.

7. The locomotion assistance assembly of claim 1, wherein the wheels include left and right rear wheels configured for differential operation, wherein operation of the left and right rear wheels at different speeds causes the cage assembly to engage in a turning motion.

8. The locomotion assistance assembly of claim 1, further comprising lower locomotion handles carried by an external frame included in the cage assembly and positioned at a lower height than the upper handles, wherein the lower locomotion handles are configured for operation when the user is in the seated position.

9. The locomotion assistance assembly of claim 1, further comprising a central drive assembly disposed at a base of the cage assembly, wherein the central drive assembly is configured to provide stability and locomotion for the assembly.

10. A locomotion assistance assembly comprising:
a frame structure;
a central drive track disposed along a length of the frame structure;
wheels connected to the frame structure for mobility of the assembly;
handles carried by the frame structure;
an arm-leg linkage connecting the handles to a position below a knee of a user;
foot supports configured for controlled ground engagement during operation of the assembly; and
wherein the arm-leg linkage is configured to provide an elliptical motion pathway for leg movement when the handles are actuated.

11. The locomotion assistance assembly of claim 10, wherein the foot supports include free-spinning elements configured to glide along a ground surface during operation.

12. The locomotion assistance assembly of claim 10, wherein the elliptical motion pathway provides knee flexion during leg movement.

13. The locomotion assistance assembly of claim 10, further comprising a chest rest configured to support the user during operation.

14. The locomotion assistance assembly of claim 10, wherein the central drive track is configured to provide a subtle lift of the foot supports during operation.

15. The locomotion assistance assembly of claim 10, wherein the foot supports are coupled to the frame structure and configured to secure and guide feet of the user during a gait pattern.

16. The locomotion assistance assembly of claim 10, wherein the frame structure includes caster wheels at a base of the frame to provide mobility and stability during operation.

17. The locomotion assistance assembly of claim 10, further comprising a sit-to-stand assembly coupled to the frame structure and configured to transition the user between a seated position and a standing position.

18. A locomotion assistance assembly comprising:
a frame providing a stabilizing cage structure configured to support a user;
a hinged gate positioned behind the user and configured to lock in a closed position;
a padded front support configured to work in conjunction with the hinged gate to encircle a torso of the user;
handles carried by the frame, the handles having a bent configuration;
a chest rest coupled to the frame; and
wheels connected to the frame for mobility of the assembly.

19. The locomotion assistance assembly of claim 18, wherein the handles are operatively connected to foot pedals disposed at a base of the frame, wherein actuation of the handles causes movement of the foot pedals.

20. The locomotion assistance assembly of claim 18, further comprising a backrest coupled to the frame and configured to function as a seat when the user is in a seated position and as a back support when the user is in a standing position.
